(19) United States
(12) Patent Application Publication
(10) Pub. No.: US 2011/0056411 A1
(43) Pub. Date: Mar. 10, 2011

(54) CEMENT ADDITIVES FOR OIL-COMPATIBLE CEMENTS

(75) Inventors: Christian Schmidt, Saarbruecken (DE); Klaus Endres, Homburg (DE); Helmut Schmidt, Saarbruecken-Guedingen (DE)

(73) Assignee: EPG (ENGINEERED NANOPRODUCTS GERMANY) AG, Zweibruecken (DE)

(21) Appl. No.: 12/746,823

(22) PCT Filed: Dec. 9, 2008
(86) PCT No.: PCT/EP2008/067092

§ 371 Date: Aug. 16, 2010

(30) Foreign Application Priority Data
Dec. 10, 2007 (DE) 10 2007 059 424.2

(51) Int. Cl. C04B 16/00; B32B 37/00; B32B 37/24; B82Y 30/00

(52) U.S. Cl. 106/806; 106/481; 156/60; 156/245; 977/773; 977/811; 977/902

(57) ABSTRACT

A process for the preparation of a cement material for cementing. The process comprises adding to a cement material comprising cement and water a precondensate of at least one hydrolysable organosilane and, optionally, (nanoscale) particles.

The present invention relates to a process for the preparation of a cement material for cementing, the use of the cement material for cementing and a cement additive kit.

Cements are inorganic hydraulic binders, i.e. they set with water to give a compact molding; monocalcium silicate present therein is converted thereby into tricalcium silicate, which crystallizes as fine needles which intermesh and thus bring about the strength of the cement block. Cement mortars are aqueous mixtures of milled cement with sand. Concretes are aqueous mixtures of milled cement with concrete aggregates, e.g. relatively coarse gravel.

In the petroleum industry, cements are used in a very wide variety of manners. One important use is for fixing the casing in the well, in which the gap between the casing and the surrounding rock is filled with cement. Since oil-containing formations are also pierced during the drilling, both the casing and the formation come into contact with oil. If organic drilling fluids (generally diesel oil fractions) are used during drilling, the entire casing and the entire formation comes into contact with oil over the total length.

During fixing, the oil mixes with the cement, resulting in a loss of strength and/or in the formation of layers which constitute weak points. In addition, the cement frequently no longer adheres well to the casing or the formation, resulting in loss of tightness, which leads to leakages of various liquids which are used in the production process (e.g. acids for cleaning, etc). The resulting losses of strength can lead to cracking and also to leaks. Moreover, the fixing of the casing is weakened by the loss of liquid. This is further exacerbated by the fact that normal cements have relatively poor adhesion to oil-contaminated surfaces. This is evident, for example, from the fact that the formwork boards are oiled in order to enable them to be removed again easily after hardening of, for example, concrete.

For said reasons, it is desirable to have cements available which are insensitive to the penetration of oil, avoid strength losses and moreover have good adhesion to oil-contaminated casings.

In the prior art, numerous investigations which relate to the use of emulsifiers were carried out by way of remedy. As a rule, better miscibility with oil is observed thereby. However, it is found that the strength of the cements generally decreases substantially but there is in general no improvement in the adhesion of the cement to the casing.

It has now surprisingly been found that substantially improved miscibility of the cement with oil is achievable by addition of hydrolysis products or condensates or precondensates of hydrolysable organosilanes, for example precondensates of methyl silanes, which can be prepared from corresponding alkoxy silanes via hydrolysis and, if appropriate, partial condensation. Thus, 30% of oil can be added to the cements without phase separation occurring. However, here too a substantial decrease in the strength occurs. On simultaneous or subsequent addition of nanoscale silica, however, the strength loss can surprisingly be virtually completely compensated. However, silica has an accelerating effect on the setting process, but this can be readily adjusted within the technically required range by commercially available retardants.

Accordingly, the present invention relates to a process for the preparation of a cement material for cementing, in which a precondensate of at least one hydrolysable organosilane is added to a cement material comprising cement and water and intended for cementing.

Surprisingly, substantially improved miscibility of the cement with oil can be achieved by the addition of the precondensate, so that the cement can be readily used for cementing even in the case of oil-containing substrates or oil-containing geological formations. The resulting strength loss can be compensated by addition of nanoscale SiO₂ particles. The setting time of the cement material can be adjusted as desired by commercially available accelerators or retardants.

Without wishing to be bound by a theory, it is assumed that the action of the precondensate, in particular of alkyl alkoxy silanes, can be explained as follows. Owing to the bipolar property of the hydrolysis product or condensate, the hydrophilic regions (OH groups) can interact with the cement components while the hydrophobic regions group around the oil droplets in the manner of micelle formation. Sufficiently intensive mixing of the oil phase with the cement phase is expedient for bringing about this process. Whereas cement which does not contain these components separates again in a short time, this does not take place in the case of the additive-containing cements.

The distribution of the oil in a cement containing the precondensate is so fine that it is not visible either to the unaided eye or under a microscope. Once again without wishing to be bound by a theory, the outstanding long-term stability of the distribution can be explained by the binding of the micelles to the cement structure: the OH groups of the silane hydrolysis products or condensates can link to the structure of the cement via pure Si—O—Si bonding but also to one another via ionic bonding via the calcium (⁺Ca⁺—⁻O—Si—). In this context, the strongly consolidating effect of colloidal silicas is also understandable: they can both bind cement components and produce consolidating structures via the hydrophilic surfaces of the micelles.

The adhesion of the cement on oil-contaminated metal surfaces can also be explained by similar mechanisms. Here too, the bipolar hydrolysis products or condensates act as mediators between the hydrophilic cement matrix and the oil-contaminated (and therefore hydrophobic) metal surface. The invention is explained in detail below.

In the process according to the invention, a cement material for cementing is prepared by adding water and a precondensate of at least one organosilane to the cement. The precondensate can be added to the cement simultaneously with the water or preferably after the addition of the water. For this purpose, the cement is mixed with the water to give a slurry, to which the precondensate is added.

The precondensate is preferably fluid or viscous. The precondensate is formed from at least one hydrolysable organosilane. One or more organosilanes may be used. A hydrolysable organosilane is a silicon compound which comprises at least one hydrolysable group and at least one nonhydrolysable organic group. Silanes can be prepared by known methods; cf. W. Noll, “Chemie and Technologie der Silicone [Chemistry and Technology of Silicones]”, Verlag Chemie GmbH, Weinheim/Bergstraβe (1968).

Examples of such hydrolysable organosilanes are silanes of the general formula (I)

RₙSiX₄₋ₙ (I)

in which the groups X are identical or different from one another and are hydrolysable groups or hydroxyl groups, the radicals R are identical or different from one another and represent a nonhydrolysable organic group and n is 1, 2 or 3, preferably 1 or 2 and in particular 1.

Specific examples of hydrolysable groups X in the general formula (I) are halogen atoms, e.g. chlorine and bromine, alkoxy groups and acyloxy groups having up to 6 carbon atoms. X is particularly preferably an alkoxy group, in particular a C₁₋₄-alkoxy group, such as methoxy, ethoxy, n-propoxy and isopropoxy, methoxy and ethoxy groups being particularly preferred. Halogen atoms may not be so expedient as group X if resulting anions, such as Cl⁻, show incompatibilities with the cement.

Specific examples of nonhydrolysable organic groups R in the general formula (I) are alkyl, alkenyl and alkynyl groups and aryl, aralkyl and alkaryl groups, which in each case preferably comprise not more than 20 carbon atoms. Alkyl, alkenyl and alkynyl groups having up to 4 carbon atoms and aryl, aralkyl and alkaryl groups having 6 to 10 carbon atoms are preferred. Specific examples of such groups are methyl, ethyl, n-propyl, isopropyl, n-butyl, sec-butyl and tert-butyl, phenyl, tolyl and benzyl. The groups may have customary substituents, but the groups preferably carry no substituents. Preferred groups R are alkyl groups having 1 to 4 carbon atoms, in particular methyl and ethyl, and phenyl.

Particularly preferred hydrolysable organosilanes are alkyl- and aryltrialkoxy silanes. Examples are methyltriethoxysilane (MTEOS), methyltrimethoxysilane (MTMS), ethyltrimethoxysilane and ethyltriethoxysilane or phenyltriethoxysilane. Dialkyisilanes, such as dimethyldiethoxysilane, are also suitable. A hydrolysable silane without nonhydrolysable groups, such as tetraethoxysilane or tetramethoxysilane, can optionally also be added to the organosilane for hydrolysis. Preferably, however, only hydrolysable organosilanes are used for the precondensate.

Here, the precondensate of at least one hydrolysable organosilane is understood as meaning a hydrolysis product or condensate of the at least one hydrolysable organosilane. The hydrolysis products or condensates are in particular hydrolysed or partly condensed compounds of the hydrolysable organosilanes. For the preparation of the precondensate to be added to the cement, preferably one or more hydrolysable organosilanes are subjected to a hydrolysis. Depending on the conditions present, the hydrolysed species formed in the hydrolysis tend to undergo condensation reactions, so that hydrolysed and/or partly condensed species of the hydrolysable organosilanes may be present in the precondensate. Alternatively, already precondensed compounds can also be used as the precondensate. Such oligomers may be, for example, straight-chain or cyclic low molecular weight partial condensates (e.g. polyorganosiloxanes) having a degree of condensation of, for example, about 2 to 100, in particular about 2 to 6.

The precondensates are preferably obtained by hydrolysis and optionally partial condensation of the hydrolysable starting compounds, preferably by the sol-gel process. The hydrolysis can be carried out in the presence of a solvent, such as an alcohol, but preferably no solvent is added. The weight ratios mentioned further below relate to a precondensate where no solvent was added during the preparation. In the sol-gel process, the hydrolysable compounds are hydrolysed with water, optionally in the presence of acidic or basic catalysts, and optionally subjected to partial condensation. Preferably, the hydrolysis and condensation are effected in the presence of acidic catalysts (e.g. hydrochloric acid, phosphoric acid or formic acid) at a pH of preferably 1 to 3. The resulting sol can be adjusted to the viscosity desired for the precondensate by suitable parameters, e.g. degree of condensation, solvent or pH. Further details of the sol-gel process are described, for example, by C. J. Brinker, G. W. Scherer: “Sol-Gel Science—The Physics and Chemistry of Sol-Gel-Processing”, Academic Press, Boston, San Diego, New York, Sydney (1990).

The hydrolysable organosilane can be hydrolysed with stoichiometric amounts of water but also with smaller or larger amounts, based on the hydrolysable groups present (groups X in the formula (I)). Preferably, a substoichiometric amount of water, based on the hydrolysable groups present, is used. The amount of water used for hydrolysis and condensation of the hydrolysable compounds is preferably 0.1 to 0.9 and more preferably 0.2 to 0.5 mol of water per mole of the hydrolysable groups present (R_{OR}=0.1 to 0.9, preferably 0.2 to 0.5). Often, particularly good results are obtained with about 0.4 mol of water per mole of the hydrolysable groups present.

In a preferred embodiment, the pH of the precondensate is approximately neutral, e.g. between 6 and 8. It may therefore be expedient to add a base to the precondensate prepared, for example if the precondensate formed during the hydrolysis has an acidic value, for example owing to the use of an acid as a catalyst. Suitable bases are, for example, alkali metal and alkaline earth metal hydroxides, alkali metal or alkaline earth metal carbonates, alkali metal or alkaline earth metal alcoholates and acetates. A specific example is sodium methanolate, which can be used in solution in ethanol. On the other hand, the addition of an acid may also be expedient in order to neutralize a precondensate obtained by basic catalysis.

In a preferred embodiment, particles, preferably nanoscale particles, are also added to the cement material. The particles are in particular particles of metal or semimetal compounds, in particular metal or semimetal oxides. All metals or semimetals (also abbreviated together as M below) can be used for this purpose. Suitable metals or semimetals M for the metal or semimetal compounds are, for example, Mg, B, Al, Ga, In, Si, Ge, Sn, Pb, Y, Ti, Zr, V, Nb, Ta, Mo, W, Fe, Cu, Ag, Zn, Cd, Ce and La or mixtures thereof. The particles can be prepared in various ways, for example by flame pyrolysis, plasma methods, colloid techniques, sol-gel processes, controlled nucleation and growth processes, MOCVD methods and emulsion methods. These methods are described in detail in the literature.

Examples are particles comprising (optionally hydrated) oxides, such as ZnO, CdO, SiO₂, GeO₂, TiO₂, ZrO₂, CeO₂, SnO₂, Al₂O₃ (in particular boehmite, AlO(OH), also as aluminium hydroxide), B₂O₃, In₂O₃, La₂O₃, Fe₂O₃, Fe₃O₄, Cu₂O, Ta₂O₅, Nb₂O₅, V₂O₅, MoO₃ or WO₃; phosphates, silicates, zirconates, aluminates, stannates of metals or semimetals, and corresponding mixed oxides. Preferred particles are SiO₂, Al₂O₃, AlOOH, Ta₂O₅, ZrO₂ and TiO₂, aluminium oxides, zirconium dioxide and SiO₂ being more preferred. All these particles are preferably used as nanoscale particles. Most preferred are SiO₂ particles, in particular nanoscale SiO₂ particles.

The strength of the set cement is increased by the particles and in particular by the nanoscale particles, in particular nanoscale aluminium, zirconium and silicon oxide particles, so that strength losses can be compensated by the addition of the precondensate. The particles can be added as powder or preferably in a liquid medium, such as water, in particular as a sol, and a colloidal silica is preferably used. The particles, in particular the nanoscale particles, can be added simultaneously with the precondensate to the cement material; they are preferably admixed after the addition of the precondensate.

Such particles, such as SiO₂ particles, which are used, for example, in large amounts as fillers, are commercially available. For example, silica products, e.g. silica sols, such as the Levasils®, silica sols from Bayer AG, or pyrogenic silicas, e.g. the Aerosil products from Degussa, can be used. The particulate materials can be added in the form of powders and sols.

The size of the particles used can be chosen according to requirements. The particles used are preferably nanoscale. Nanoscale particles are understood as meaning particles having a median particle diameter, based on the volume average (d₅₀ value), of not more than 1000 nm, preferably not more than 200 nm and in particular not more than 100 nm. The size can be determined, for example, by a laser optical method using dynamic laser light scattering, for example with a UPA (Ultrafine Particle Analyser, Leeds Northrup).

The amount of precondensate and optionally of particles which are added to the cement material can be chosen by the person skilled in the art within wide ranges and according to desired properties of the cement. The precondensate is used, for example, preferably in an amount of 0.5 to 10% by weight, based on the weight of the cement. The amount of optional particles, in particular SiO₂ particles, depends on the desired degree of strength. For Levasil® 300/30, for example, an amount of 5 to 50% by weight, based on the weight of the cement, may be expedient, the water in the Levasil being taken into account. If only the particles are taken into account, without the optionally present liquid medium in which they are dispersed for the addition, generally, for example, an amount of 1 to 20% by weight of particles, preferably nanoscale particles, particularly preferably nanoscale SiO₂ particles, based on the weight of the cement, may be expedient.

The cement used may be any commercially available cement, for example and without restriction, Portland cement, slag cement, pozzolanic cement, high-alumina cement, asbestos cement and expanding cement, with Portland cements being preferred.

Sand, and other materials usually added to concrete or customary additives (concrete admixtures and concrete additives), such as, for example, accelerators, retardants, diffusion-inhibiting additives (diffusion blockers), concrete plasticizers, air-entraining agents, concrete waterproofing compounds, grouting aids, mineral and organic concrete additives, can be added as required in the customary amounts to the cement or the cement material. These are known in the cement industry and are used according to the desired properties of the cement. Reference is made, for example, to the information in Uiimanns Encyciopadie der technischen Chemie [Ullmann's Encyclopaedia of Industrial Chemistry], 4th edition, vol. 8, under the title “Baustoffe [Building materials]”. For example sand or materials usually added to concrete can be added to the cement for use as mortar or concrete. The sequence of the addition of all these added materials is arbitrary and can be carried out in the customary manner; they can, for example, be mixed with the cement before the addition of the water or added at a later time.

Examples of retardants customary in the cement industry are alkyl sulphonates, sucrose, phosphonic acid derivatives (PBTC) or tetrapotassium pyrophosphate. Examples of diffusion blockers customary in the cement industry are soluble silicates and silicofluorides, milled slag, pumice, diatomite, fly ash, silica dust, stearic, caprylic and oleic acids or the sodium, ammonium, sulphonium and aluminium salts thereof Examples of accelerators customary in the cement industry are chlorides, such as calcium chloride, carbonates, aluminates, silicates, nitrates and nitrites. For further examples of usable additives and materials added to concrete, reference is made to manuals of cement technology.

The setting time of the cement can be adjusted as desired by a retardant or an accelerator. Since optionally added particles, preferably SiO₂ particles, can accelerate the setting process, a retardant is added to the cement material in a preferred embodiment.

Accordingly, the invention also relates to the use of a precondensate of at least one hydrolysable organosilane as a cement additive and preferably the use of a combination of the precondensate and particles, preferably nanoscale particles, as cement additives. The invention also relates to a cement additive kit which preferably comprises, as separate components, a precondensate of at least one hydrolysable organosilane as a first component and particles, preferably nanoscale particles, as a second component. The particles of the kit are preferably SiO₂ particles and in particular nanoscale SiO₂ particles. The particles are preferably present as a sol, preferably as an aqueous sol.

According to the invention, the cement is stirred with water to give a slurry. After addition of the precondensate and optionally of particles and further additives or added materials, the cement material can be used for cementing. In a preferred embodiment, the cement is mixed with water to give a slurry, the precondensate is then added and a silica sol is added after further thorough mixing of the cement slurry, and mixing is effected again. Depending on the desired setting behaviour, an accelerator or retardant may be added.

The cement material of the present invention can be used for any application for which conventional cements are also used. The cement material prepared is suitable in particular for substrates and geological formations which contain oil, since the cement material is oil-compatible.

The cement material is suitable, for example, for fixing objects, for example comprising metal, such as iron or steel, on or in a substrate or geological formation or for filling, consolidating or sealing substrates or geological formations. Examples of geological formations are soils and formations comprising sand, earth or sandstone and other mineral formations, in particular all types of rock. The substrates may comprise, for example, sand, gravel, stone, metal, plastic or ceramic. The substrates may be, for example, stones, masonry, soils, reinforcement or porous or unbound moldings.

The geological formations or substrates may have, for example, pores, voids, channels, fissures or cracks into which the cement material can penetrate. The substrates may also be a more or less loose structure of discrete components, such as sand particles, stones or other particles, in which the voids between the discrete components form pores or channels.

For cementing, the cement material is applied to or introduced into the substrate or the geological formation where it then sets or hardens. The hardening can, if required, also be effected at elevated temperature and/or elevated pressure. An object which is brought into contact with the cement material can be fixed in this way to or in the substrate or the geological formation. The cement material can, for example, be pumped or infiltrated into the porous moldings, rocks or formations, which can optionally be supported by application of pressure. The cement slurry which is penetrated into the pores, fissures or channels of the moldings, rocks or formations solidifies after a certain time and thus ensures the desired fixing, sealing or consolidation.

The cement material is preferably used for sealing or consolidating geological formations of petroleum or natural gas fields, for example by pressure cementing of oil well matrices or formations or of landfills or other oil-contaminated formations or for fixing objects, such as pipes or lines in such geological formations. In a particularly preferred embodiment, for fixing a pipe in a well, the cement material is introduced into the gap between the pipe and the surrounding geological formation.

There follow examples for the further explanation of the invention, which however are not intended to limit it in any way.

### EXAMPLES

### Preparation of the Precondensate

3.6 g of 0.1 M HC1 are added to 30 g of methyltriethoxysilane (MTEOS) at RT and the mixture is rigorously stirred. After the clear point, the reaction solution is stirred for a further hour at RT and then 121 mg of a 21% by weight sodium ethanolate solution in EtOH are added for neutralization. The slightly turbid solution thus obtained can be used without further working-up.

### Formulation of the Cement Material

150 g of Portland cement (II/B) are mixed with 55 g of water. Thereafter, 4.6 g of the precondensate prepared above (R_{OR}=0.4) are added and the cement slurry is thoroughly mixed. 28 g of Levasil® 300/30 and 4.5 g of CaCl₂ are added to the mixture obtained and mixing is effected again. Preferred mixing speeds during the cement preparation are 2000 to 12 000 rpm.

### Results

The cement material prepared was tested with regard to the absorptivity of oil and compared with a corresponding comparative cement material without addition of the precondensate. For this purpose, cylindrical samples (16 mm×6 cm) with different amounts of oil (Hisop® 220) were prepared using the cement materials. The hardening was effected at 60° C. at atmospheric pressure under water for 24 h in each case. The hardening can also be effected at RT or other temperatures or pressures. In each case the uniaxial compressive strength (UCS) was determined.

| | Cement of the | Comparative |
|---|---|---|
| Added amount of oil | invention UCS [MPa] | cement UCS [MPa] |
| 0% by weight | 10.9 | 8.2 |
| 10% by weight | 7.1 | 3.7 |
| 20% by weight | 4.2 | —* |
| 30% by weight | 3.6 | —* |

*Phase separation of the oil

The cement material obtained according to the invention can absorb up to 30% by weight of oil without phase separation occurring, whereas phase separation occurs in the case of the comparative cement on addition of only 20% by weight of oil.

1.-24. (canceled)

25. A process for the preparation of a cement material for cementing, wherein the process comprises adding to a cement material comprising cement and water a precondensate of at least one hydrolysable organosilane.

26. The process of claim 25, wherein the process further comprises adding particles to the cement material simultaneously with or following an addition of the precondensate.

27. The process of claim 26, wherein the particles comprise nanoscale particles.

28. The process of claim 27, wherein the nanoscale particles comprise one or more oxides of at least one of aluminum, zirconium, and silicon.

29. The process of claim 28, wherein the nanoscale particles comprise a silica sol.

30. The process of claim 25, wherein the hydrolysable organosilane comprises at least one of an alkyl silane and an aryl silane.

31. The process of claim 25, wherein the precondensate has been obtained by hydrolyzing the at least one hydrolysable organosilane with water.

32. The process of claim 31, wherein the at least one hydrolysable organosilane has been hydrolyzed with a substoichiometric amount of water, based on hydrolysable groups of the silane.

33. The process of claim 25, wherein the precondensate is added simultaneously with or following an addition of water to the cement.

34. The process of claim 25, wherein the cement material comprises at least one of sand and concrete aggregates.

35. The process of claim 25, wherein the process further comprises adding to the cement material an accelerator or a retardant for adjusting a setting behavior of the cement material.

36. The process of claim 26, wherein the process comprises mixing the cement and water to form a slurry, mixing the precondensate with the slurry and simultaneously or subsequently adding nanoscale particles.

37. The process of claim 25, wherein the cement comprises Portland cement.

38. A cement material obtainable by the process of claim 25.

39. A process for cementing a substrate or a geological formation, wherein the process comprises applying to or introducing into the substrate or geological formation the cement material of claim 38.

40. The process of claim 39, wherein the substrate or geological formation comprises oil.

41. The process of claim 39, wherein an object is fixed on or in the substrate or geological formation using the cement material.

42. The process of claim 41, wherein, for fixing a pipe in a well, the cement material is introduced into a gap between the pipe and a surrounding geological formation.

43. The process of claim 39, wherein for sealing or consolidation, the cement material is introduced into at least one of a porous molding, a rock and a geological formation.

44. The process of claim 39, wherein the cement material is pumped or infiltrated into at least one of a porous molding, a rock and a geological formation.

45. The process of claim 39, wherein the geological formation at least one of belongs to a petroleum or natural gas field or a landfill and is contaminated with oil.

46. A combination of a precondensate of at least one hydrolysable organosilane and a cement.

47. The combination of claim 46, wherein the combination further comprises particles.

48. The combination of claim 47, wherein the particles comprise nanoscale particles.

49. The combination of claim 48, wherein the nanoscale particles comprise nanoscale SiO₂ particles.

50. A cement additive kit, wherein the kit comprises a precondensate of at least one hydrolysable organosilane as a first component and particles as a second component.

51. The kit of claim 50, wherein the particles comprise nanoscale particles.
